(19) United States
(12) Patent Application Publication
(10) Pub. No.: US 2005/0254016 A1
(43) Pub. Date: Nov. 17, 2005

(54) Projector

(75) Inventor: Takeshi Ono, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/124,353

(22) Filed: May 9, 2005

(30) Foreign Application Priority Data
May 11, 2004 (JP) 2004-141113

(51) Int. Cl. G03B 21/16

(52) U.S. Cl. 353/61

(57) ABSTRACT

Exemplary embodiments provide a projector by which quality of projection images are ensured even when the attitude of the projector changes. A projector includes a light source, a liquid crystal panel as an optical conversion unit to convert the exiting light from the light source, and a cooling device to cool the liquid crystal panel using a cooling medium. The cooling device includes a circulation pipe for the cooling medium, a circulation pump to circulate the cooling medium, a detection switch, as a detecting unit to detect that the circulating direction of the cooling medium in the liquid crystal panel to be cooled is the attitude for circulating from top to bottom, and a switching unit to switch the circulating direction of the cooling medium to cool the liquid crystal panel so that the circulating direction of the cooling medium may be from bottom to top based on the detection result by the detection switch.

### BACKGROUND

Exemplary embodiments of the present invention relate to a projector having a cooling device using a cooling medium.

The related art includes projectors that have higher brightness and project images that have become clearer and easier to view. Accordingly, the projectors have been utilized in various places such as companies, event sites, schools, and homes. Methods of installing the projectors in such places include a method of installing the projector on a desk or the like for projection on a screen. Additionally, projectors are installed at a high place such as a ceiling, using a fixing jig for projection. Here, the positional relationship of the projection image projected from the projector to the projector main body is basically designed with reference to the case where the projector is installed on a desk, and designed so as to project the projection image on the screen in the position above the installed projector main body by “tilt” of the projection lens. As such, when the projector is installed on the ceiling so that the bottom surface of the projector may be seen, the projection image is projected not on the screen, but on the ceiling plane. Accordingly, when the projector is installed on the ceiling or the like, it is necessary to install the projector main body upside down, (in a state in which the top surface of the projector may be seen from below). In this case, a user can perform processing on projection images projected on the screen of turning the projection image upside down by switching operation with an operation unit and circuit unit mounted on the projector. Accordingly, projection images in a normal state can be projected.

Further, because of the progress toward higher brightness projectors, in liquid crystal panels as optical conversion units within the projector, the amount of heat liberated by exiting light of light sources has become increasingly larger.

Related art document JP-A-6-189240 includes a liquid cooling system for cooling the liquid crystal panel that generates heat using a cooling medium. For example, there is proposed that a container formed by a transparent member is fixed to the liquid crystal panel that generates heat, the container is filled with a cooling medium, and the container is connected to a cooling device including a connecting pipe, a liquid feed pump, and a radiator, and the liquid crystal panel is cooled by air cooling the radiator with a cooling fan.

### SUMMARY

However, in the case of using the projector main body upside down, when the liquid cooling system is used as disclosed in related art document JP-A-6-189240, the cooling path is structurally turned upside down and thus, the inflow direction and outflow direction of a box-shaped cooling unit provided for the liquid crystal panel as a heat generating member are reversed. Specifically, in the case of desktop installation, the cooling medium circulates from bottom to top of the box-shaped cooling unit, however, in the case of installation on the ceiling, because the projector main body is turned upside down, the cooling medium circulates from top to bottom in the box-shaped cooling unit. In this case, there is a problem that the heated cooling medium can not be flown out efficiently in the box-shaped cooling unit, and consequently, the cooling efficiency is reduced.

Further, due to the heat generation of the liquid crystal panel, sometimes fine air bubbles are produced within the cooling medium because the cooling medium itself is heated by heat transferred to the cooling medium filled in the box-shaped cooling unit or the like. In the case of installation on the desk, because the moving direction of the air bubbles (movement from bottom to top) and the circulating direction of the cooling medium (circulation from the inflow side at the bottom to the outflow side at the top) are the same, the air bubbles move from the box-shaped cooling unit toward the outside with the flow of the cooling medium and no air bubble remains in the box-shaped cooling unit. However, when the projector is turned upside down by installing on the ceiling, because the cooling medium circulates from top to bottom in the box-shaped cooling unit, the moving direction of the air bubbles (movement from bottom to top) is opposite to the inflow direction, and air bubbles remain in the box-shaped cooling unit.

Further, in the case of installation on the desk, because the temperature distribution of the cooling medium within the box-shaped cooling unit is never disturbed by the circulation of the cooling medium from bottom to top, the temperature distribution uniformly changes. However, when the projector is turned upside down by being installed on the ceiling, because the cooling medium circulates from top to bottom, the temperature distribution of the cooling medium within the box-shaped cooling unit is disturbed.

Thus, in the case where an image is projected on the screen in a condition in which the projector is turned upside down by being installed on the ceiling, the produced air bubbles remain in the box-shaped cooling unit. Accordingly, the temperature distribution is disturbed and appears as a phenomenon such as “fluctuation” in the projection image, and causes deterioration in quality of the projection image.

Exemplary embodiments of the invention address the above described and/or other problems. In the construction, including a cooling device for cooling an optical conversion unit using a cooling medium, exemplary embodiments provide a projector by which quality of projection images is ensured even when the attitude of the projector changes.

In order to address and/or solve the above described and/or other problems, exemplary embodiments of the invention provide a projector for enlarging and projecting image data. The projector includes a light source, an optical conversion unit for performing conversion of exiting light from the light source, and a cooling device for cooling the optical conversion unit using a cooling medium. The projector is characterized in that the cooling medium includes a circulation path of the cooling medium, a pump for circulating the cooling medium, a detecting unit for detecting that the circulating direction of the cooling medium in the optical conversion unit to be cooled is the attitude for circulating from top to bottom, and a switching unit for switching the circulating direction of the cooling medium for cooling the optical conversion unit so that the circulating direction of the cooling medium may be from bottom to top based on a detection result by the detecting unit.

According to such a projector, the detecting unit can detect that the circulating direction of the cooling medium in the optical conversion unit to be cooled is the attitude for circulating from top to bottom. Then, when the detecting unit detects that the attitude for circulating the cooling medium in the optical conversion unit changes to the attitude for circulating from top to bottom, the switching unit can switch the circulating direction of the cooling medium in the optical conversion unit to circulate from bottom to top.

Thereby, even when the attitude of the projector is turned upside down, the heat of the optical conversion unit can be efficiently cooled. Further, regarding the production of air bubbles due to heat, air bubbles can be reduced or prevented from remaining in the place where they have been produced because the air bubbles can circulate. Further, the temperature distribution in the optical conversion unit becomes uniform. Therefore, even when the attitude of the projector is turned upside down and the direction in which the cooling medium for cooling the liquid crystal panel, for example, as the optical conversion unit circulates changes, the phenomenon “fluctuation” never occurs in the projection image on the screen, and the quality of the projection image can be ensured.

Further, according to a preferred exemplary embodiment, in the projector, the switching unit includes a valve provided within the circulation path for switching a channel and a control unit for controlling the switching of the valve based on the detection result by the detecting unit.

According to such a projector, since the switching unit includes a valve provided within the circulation path for switching a channel and a control unit for controlling the switching of the valve based on the detection result by the detecting unit, when the detecting unit detects that the attitude of the projector changes upside down, the control unit can control the valve provided within the circulation path to switch the circulating direction of the cooling medium in the optical conversion unit to be from bottom to top.

Thereby, even when the attitude of the projector is changed, the cooling efficiency in the optical conversion unit can be maintained. Further, regarding the production of air bubbles due to heat, air bubbles can be reduced or prevented from remaining in the place where they have been produced because the air bubbles can circulate. Further, the temperature distribution in the optical conversion unit becomes uniform. Therefore, even when the attitude of the projector is turned upside down and the direction in which the cooling medium for cooling the liquid crystal panel, for example, as the optical conversion unit circulates changes, the phenomenon “fluctuation” never occurs in the projection image on the screen, and the quality of the projection image can be ensured.

Further, according to a preferred exemplary embodiment, in the projector, the pump is arranged so as to switch the circulating direction of the cooling medium between a forward direction and a backward direction, and the switching unit is formed by a control unit for controlling the switching of the pump based on the detection result by the detecting unit.

According to such a projector, since the pump is arranged so as to switch the circulating direction of the cooling medium between a forward direction and a backward direction, and the switching unit is formed by a control unit for controlling the switching of the pump based on the detection result by the detecting unit, when the detecting unit detects that the attitude of the projector changes upside down, the control unit can control the pump to switch the circulating direction of the cooling medium in the optical conversion unit to be from bottom to top.

Thereby, even when the attitude of the projector is changed, the cooling efficiency in the optical conversion unit can be maintained. Further, regarding the production of air bubbles due to heat, air bubbles can be reduced or prevented from remaining in the place where they have been produced because the air bubbles can circulate. Further, the temperature distribution in the optical conversion unit becomes uniform. Therefore, even when the attitude of the projector is turned upside down and the direction in which the cooling medium for cooling the liquid crystal panel, for example, as the optical conversion unit circulates changes, the phenomenon “fluctuation” never occurs in the projection image on the screen, and the quality of the projection image can be ensured.

Further, according to a preferred exemplary embodiment, in the projector, the pump is arranged so as to switch the circulating direction of the cooling medium at least between two directions, and the switching unit is formed by a control unit for controlling the switching of the pump based on the detection result by the detecting unit and a valve provided within the circulation path for operating according to pressure by the circulation of the cooling medium and switching a channel.

According to such a projector, when the attitude of the projection is detected to be upside down, the control unit controls the pump to switch the circulating direction of the cooling medium. At this time, the valve provided within the circulation path operates according to pressure by the circulation of the cooling medium and switches a channel, and thereby, the circulating direction of the cooling medium can be circulated from bottom to top.

Thereby, even when the attitude of the projector is changed, the cooling efficiency in the optical conversion unit can be maintained. Further, regarding the production of air bubbles due to heat, air bubbles can be reduced or prevented from remaining in the place where they have been produced because the air bubbles can circulate. Further, the temperature distribution in the optical conversion unit becomes uniform. Therefore, even when the attitude of the projector is turned upside down and the direction in which the cooling medium for cooling the liquid crystal panel, for example, as the optical conversion unit circulates changes, the phenomenon “fluctuation” never occurs in the projection image on the screen, and the quality of the projection image can be ensured.

Further, according to a preferred exemplary embodiment, the projector further includes a supply tank for supplying the cooling medium and a radiation unit in the supply tank.

According to such a projector, the supply tank can supply the cooling medium and serve as a circulation path. Further, the radiation area is enlarged by the radiator provided in the supply tank, heat release efficiency can be enhanced, and the heat generated by the optical conversion unit can be sufficiently cooled by natural cooling.

Further, according to a preferred exemplary embodiment, in the projector, the detecting unit performs detection in the cases where the projector is installed on a desk and installed hanging from a ceiling.

According to such a projector, the detecting unit can detect the attitude changes between the cases where the projector is installed on a desk and installed hanging from a ceiling or the like. Accordingly, even when the attitude of the projector changes and the attitude for circulating the cooling medium in the optical conversion unit mounted on the projector changes, the heat generated by the optical conversion unit can be sufficiently cooled. Therefore, even when the attitude of the projector is changed, the cooling efficiency can be maintained. Further, regarding the production of air bubbles due to heat, air bubbles can be reduced or prevented from remaining in the place where they have been produced because the air bubbles can circulate. Further, the temperature distribution in the optical conversion unit becomes uniform. Therefore, even when the attitude of the projector is turned upside down and the direction in which the cooling medium for cooling the liquid crystal panel, for example, as the optical conversion unit circulates changes, the phenomenon “fluctuation” never occurs in the projection image on the screen, and the quality of the projection image can be ensured.

Here, the ceiling hanging installation refers to installation by fixing the projector using a jig for fixing at the high place such as a ceiling. In this case, it is necessary to install the projector main body upside down (in the condition in which the upper surface of the projector main body is seen from below).

### BRIEF DESCRIPTION OF THE DRAWINGS

FIG. 1 is a schematic showing the case where the cooling device according to the first exemplary embodiment of the invention is used for the liquid crystal panel;

FIGS. 2(a) and (b) are schematics showing operation of valves that form the switching unit;

FIG. 3 is a schematic showing the case where the cooling device according to the second exemplary embodiment of the invention is used for the liquid crystal panel;

FIG. 4 is a schematic showing the case where the cooling device according to the third exemplary embodiment of the invention is used for the liquid crystal panel; and

FIGS. 5(a) and (b) are schematics showing operation of valves that form the switching unit.

### DETAILED DESCRIPTION OF EMBODIMENTS

Hereinafter, the first exemplary embodiment of the invention will be described according to the drawings.

### First Exemplary Embodiment

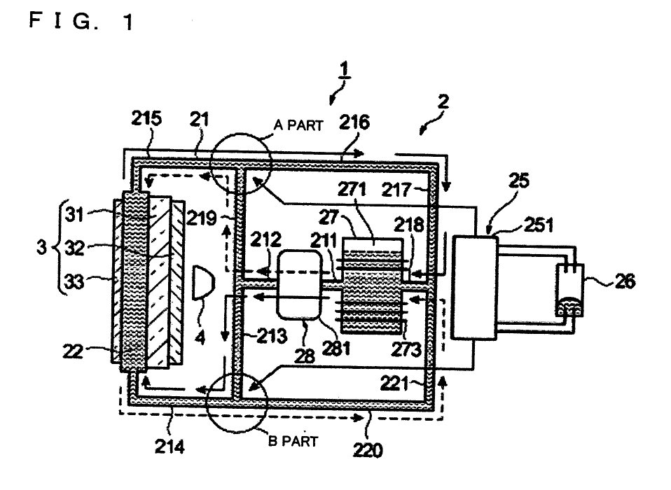

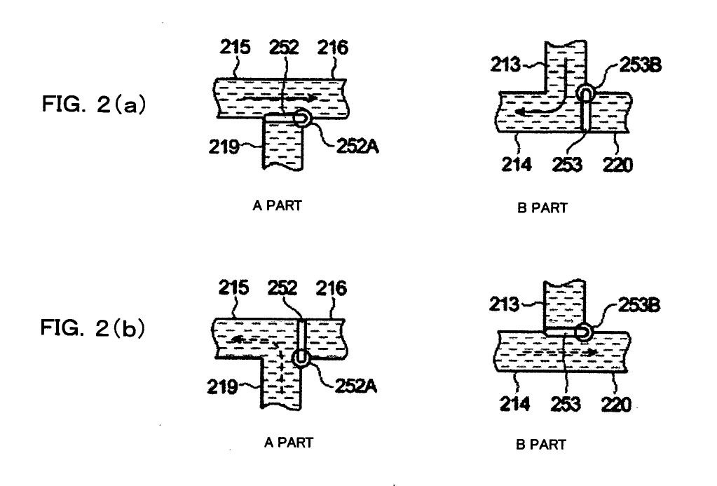

FIG. 1 is a schematic showing the case where a cooling device using a cooling medium is used in a liquid crystal panel in a projector in the exemplary embodiment. FIG. 2 is an enlarged view of A part and B part shown in FIG. 1, and shows the movement of valves that form a switching unit. Further, FIG. 2(a) shows the positions of the valves and the circulating direction of the cooling medium when the projector is installed on the desk. FIG. 2(b) shows the positions of the valves and the circulating direction of the cooling medium when the projector is installed on the ceiling (hereinafter, referred to as “ceiling hanging”). The construction and operation will be described using FIGS. 1 and 2.

A projector 1 has a cooling device 2. Further, the cooling device 2 includes a circulation pipe 21 as a circulation path for the cooling medium to circulate, a circulation pump 28 as a power source pump for circulating the cooling medium in the circulation pipe 21, a supply tank 27 for supplying and replenishing the cooling medium and cycling the cooling medium, and a box-shaped cooling unit 22 formed by a transparent member provided with an area for covering the display surface of a liquid crystal panel 3 for cooling the heat generated by the liquid crystal panel 3 as an optical conversion unit. In FIG. 1, only one liquid crystal panel 3 is shown, and three liquid crystal panels (for red, for green, and for blue) are simplified for substitution.

Further, the cooling device 2 includes a detection switch 26 as a detecting unit for detecting the attitude status of the projector 1 and a switching unit 25 for switching the circulating direction based on the detection result by the detection switch 26. The switching unit 25 includes a valve 252 and a valve 253 provided to the circulation pipe 21 and a valve control circuit 251 as a control unit for controlling the valves 252 and 253.

As the material that forms the circulation pipe 21, a tube formed by a metal containing copper having high thermal conductivity is used in the exemplary embodiment. Accordingly, the heat of the cooling medium can be transferred efficiently to the circulation pipe 21 and released into the outside air. Further, at the connection part to which stress due to torsion or the like is applied, a flame-resistant flexible tube enhanced in torsibility is used. Further, as the cooling medium circulating in the circulation pipe 21, ethylene glycol is used in the exemplary embodiment. The circulation pump 28 adopts a unidirectional circulation pump 281 (hereinafter, referred to as “circulation pump 281”) for circulating the cooling medium in a single direction. Further, the supply tank 27 provides an air reservoir 271 on the tank top, and performs operation to relax the pressure against the pressure rise within the circulation pipe 21 due to temperature rise of the cooling medium. Further, circulation pipes 211 and 218 are provided in the intermediate portion of the height direction (vertical direction) of the supply tank 27. The supply tank 27 is arranged so that the air reservoir 271 may be constantly located above the supply tank 27 even when the projector 1 is turned upside down and the cooling medium flowing between the circulation pipe 211 and the circulation pipe 218 may not be hindered even when the air reservoir 271 moves. Furthermore, a radiation fin 273 as a radiator is connected to the circumference of the supply tank 27 in some layers, cools the cooling medium by transferring the heat of the heated cooling medium and releasing the heat to the outside of the cooling device 2. By the radiation fin 273, natural cooling is realized.

The box-shaped cooling unit 22 is formed by a transparent member provided with an area for covering the display surface of a liquid crystal panel 3. The liquid crystal panel 3 includes a liquid crystal panel main body 31 formed by enclosing liquid crystal between two glass plates on which electrodes are formed, a light incident-side polarizer 32, and a light exiting-side polarizer 33, and modulates exiting light from a light source 4. Further, the box-shaped cooling unit 22 connects the light incident-side of the box-shaped cooling unit 22 to the light exiting-side surface of the liquid crystal panel main body 31 and connects the light exiting-side of the box-shaped cooling unit 22 to the light exiting-side polarizer 33. Actually, three box-shaped cooling units 22 as described above are connected serially using the circulation pipe 21 in association with three liquid crystal panels 3. Further, the box-shaped cooling unit 22 is filled with the cooling medium, and as a circulation path of the cooling medium the lower portion of the box-shaped cooling unit 22 is connected to the circulation pipe 214 and the upper portion is connected to the circulation pipe 215.

A mercury switch is used as the detection switch 26 for detecting the attitude status of the projector 1 in the exemplary embodiment for detecting the status in which the projector 1 is installed on the desk and the ceiling hanging status (in which the projector 1 is installed upside down). Simultaneously, the detection switch 26 also serves as a detection switch 26 for detecting whether the projector is in an attitude status in which the cooling medium circulating within the box-shaped cooling unit 22 provided to the liquid crystal panel 3 circulates from bottom to top (corresponding to the status of desktop installation of the projector 1) or in an attitude status in which the cooling medium circulates from top to bottom (corresponding to the status of ceiling hanging installation of the projector 1).

The switching unit 25 includes the valve 252 and the valve 253 provided within the Apart and B part of the circulation pipe 21, respectively (in FIG. 2, the valves 252 and 253 in the A part and B part are shown). Further, the unit includes the valve control circuit 251 for controlling the valves 252 and 253 according to the result detected by the detection switch 26. In the exemplary embodiment, electromagnetic valves are used as the valves 252 and 253, the valves 252 and 253 are switched between two positions by energizing the electromagnetic coils and producing magnetic force, and thereby, the circulation path is switched.

Next, the operation will be described in detail.

The circulation operation of the cooling medium in the cooling device 2 in the case where the projector 1 is installed on the desk and used will be described.

When the projector is installed on the desk, the detection switch 26 is in a status shown in FIG. 1. At this time, the valve control circuit 251 controls the valves 252 and 253 as shown in FIG. 2(a) so that the A part valve 252 may operate in a position where it blocks the circulation pipe 219 with the 252A portion as a support and the B part valve 253 may operate in a position where it blocks the circulation pipe 220 with the 252B portion as a support.

In this condition, the circulation pump 281 drives to suck in the cooled cooling medium from the supply tank 27 through the circulation pump 211. Then, the cooling medium sucked in by the circulation pump 281 is discharged into the circulation pipe 212. The cooling medium circulates in the circulation pipe 213 because the circulation pipe 219 is closed by the valve 252. Then, the cooling medium circulates in the circulation pipe 214 because the circulation pipe 220 is closed by the valve 253. Then, the cooling medium flows from the lower side into the box-shaped cooling unit 22 connected to the circulation pipe 214.

The heat generated by the light incident-side polarizer 32 and the liquid crystal panel main body 31 and the heat generated by the light exiting-side polarizer 33 due to exiting light from the light source 4 of the projector 1 are transferred to the box-shaped cooling unit 22, and thereby, transferred to the cooling medium flown in the box-shaped cooling unit 22. Then, the heated cooling medium by the heat transfer flows out into the circulation pipe 215 connected to the upper side of the box-shaped cooling unit 22. The delivery of heat by the heat transfer cools the liquid crystal panel main body 31, the light incident-side polarizer 32, and the light exiting-side polarizer 33 that have transferred the generated heat to the box-shaped cooling unit 22, respectively.

The reason that the cooling medium within the box-shaped cooling unit 22 is circulated from bottom to top is to utilize the nature that liquid or gas moves upwardly when heated. When the cooling medium is circulated from bottom to top, the heated cooling medium can flow out toward above without remaining within the box-shaped cooling unit 22. Therefore, the cooling efficiency is enhanced or improved. Contrarily, when the cooling medium is circulated from top to bottom, the heated cooling medium is circulated reversely to the upward movement within the box-shaped cooling unit 22 according to the nature of liquid, the heated cooling medium becomes hard to flow out from the box-shaped cooling unit 22, the heated cooling medium remains within the box-shaped cooling unit 22, and the cooling efficiency becomes reduced.

The liquid crystal panel 3 generates heat due to the exiting light of the light source 4 and the generated heat is transferred to the box-shaped cooling unit 22 to heat the cooling medium. At this time, the cooling medium sometimes produce fine air bubbles by being heated. However, since the produced air bubbles flow from bottom to top of the box-shaped cooling unit 22 in the same direction as the circulation direction of the cooling medium, they never remain within the box-shaped cooling unit 22 but flows out into the circulation pipe 215. Further, thereby, the temperature distribution of the cooling medium within the box-shaped cooling unit 22 becomes stable as it flows from bottom to top in a condition in which the temperature uniformly becomes higher.

Here, the cooling medium is defoamed before filling in the cooling device 2 without fail for removing air bubbles existing in the cooling medium. However, since the air bubbles can not be completely removed by the defoaming, when heat is applied to the cooling medium or the like, fine air bubbles are produced. Those air bubbles remain within the box-shaped cooling unit 22, and that causes the phenomenon “fluctuation” in the projection image on the screen.

Further, when the temperature distribution of the cooling medium within the box-shaped cooling unit 22 is in a condition in which the temperature uniformly becomes higher as the cooling medium flows from bottom to top, the “fluctuation” is hard to occur, however, when the temperature distribution is disturbed, the “fluctuation” becomes easy to occur.

The cooling medium that has flown out from the box-shaped cooling unit 22 circulates in the circulation pipe 215 and then circulates in the circulation pipe 216 because the circulation pipe 219 is closed by the A part valve 252. Then, the cooling medium circulates in the circulation pipe 217. Then, the cooling medium circulates in the circulation pipe 218 because the circulation pipe 220 is closed by the B part valve 253 and the circulation pipe 221 connected thereto is similarly closed, and then, flows into the supply tank 27.

The heated cooling medium that has flown in the supply tank 27 is naturally cooled by the heat release with the radiation fin 273 provided in the supply tank 27.

The above described series of circulation paths of the cooling medium at the time of desktop installation are shown by solid line arrows in FIGS. 1 and 2(a). Through the series of circulation, the liquid crystal panel 3 that has generated heat is cooled. Further, through the series of circulation, the cooling medium draws heat from the liquid crystal panel 3 that has generated heat by heat transfer and is naturally cooled by the radiation fin 273 of the supply tank 27.

Next, the circulation movement of the cooling medium in the cooling device 2 when the projector 1 is installed hanging from the ceiling and used will be described.

The projector 1 is, for ceiling hanging installation, installed with the upper surface of the projector 1 down. Then, in the detection switch 26, the mercury moves in the opposite direction to that shown in FIG. 1 and reversed to the position in the case of desktop installation. The valve control circuit 251 receives the output signal of the detection switch 26 and controls the Apart valve 252 and B part valve 253.

FIG. 2(b) shows the status in which the valves 252 and 253 are controlled under the control of the valve control circuit 251.

As shown in FIG. 2(b), the A part valve 252 operates in a position where it blocks the circulation pipe 216 with the 252A portion as a support under the control of the valve control circuit 251. Further, the B part valve 253 operates in a position where it blocks the circulation pipe 213 with the 253B portion as a support.

In this condition, the circulation pump 281 drives to suck in the cooled cooling medium from the supply tank 27 through the circulation pump 211. Then, the cooling medium sucked in by the circulation pump 281 is discharged into the circulation pipe 212. The cooling medium circulates in the circulation pipe 219 because the circulation pipe 213 is closed by the valve 253. Then, the cooling medium circulates in the circulation pipe 215 because the circulation pipe 216 is closed by the valve 252. Then, the cooling medium flows from the lower side (since the projector 1 is installed with the attitude upside down, all of the components mounted in the projector 1 such as the cooling device 2 and liquid crystal panel 3 are turned upside down) into the box-shaped cooling unit 22 connected to the circulation pipe 215.

The heat generated by the light incident-side polarizer 32 and the liquid crystal panel main body 31 and the heat generated by the light exiting-side polarizer 33 due to exiting light from the light source 4 are transferred to the box-shaped cooling unit 22, and thereby, transferred to the cooling medium flown in the box-shaped cooling unit 22 in the same manner as in the case of desktop installation of the projector 1. Then, the heated cooling medium by the heat transfer flows out into the circulation pipe 214 connected to the upper side of the box-shaped cooling unit 22 (because the projector 1 is turned upside down). The delivery of heat by the heat transfer cools the liquid crystal panel main body 31, the light incident-side polarizer 32, and the light exiting-side polarizer 33 that have transferred the generated heat to the box-shaped cooling unit 22, respectively.

At this time, in the same manner as in the case of desktop installation of the projector 1, the cooling medium sometimes produces fine air bubbles by being heated. However, since the produced air bubbles flow from bottom to top of the box-shaped cooling unit 22 in the same direction as the circulation direction of the cooling medium, they never remain within the box-shaped cooling unit 22 but flows out into the circulation pipe 214. Further, thereby, the temperature distribution of the cooling medium within the box-shaped cooling unit 22 becomes stable as it flows from bottom to top in a condition in which the temperature uniformly becomes higher.

The cooling medium that has flown out from the box-shaped cooling unit 22 circulates the circulation pipe 214 and then circulates in the circulation pipe 220 because the circulation pipe 213 is closed by the B part valve 253. Then, the cooling medium circulates in the circulation pipe 221. The cooling medium circulates in the circulation pipe 218 because the circulation pipe 216 is closed by the A part valve 252 and the circulation pipe 217 connecting thereto is similarly closed, and then, flows into the supply tank 27.

The heated cooling medium that has flown in the supply tank 27 is naturally cooled by the heat release with the radiation fin 273 provided in the supply tank 27.

The above described series of circulation paths of the cooling medium at the time of ceiling hanging installation are shown by broken line arrows in FIGS. 1 and 2(b). Through the series of circulation, even when the projector 1 is installed hanging from the ceiling with the attitude of the projector 1 upside down, the liquid crystal panel 3 that has generated heat is cooled in the same manner as in the case of desktop installation of the projector 1. Further, through the series of circulation, the cooling medium draws heat from the liquid crystal panel 3 that has generated heat by heat transfer and is naturally cooled by the radiation fin 273 of the supply tank 27.

The following effects are obtained according to the above described first exemplary embodiment.

(1) The cooling device 2 in the first exemplary embodiment includes the box-shaped cooling unit 22 provided in the liquid crystal panel 3 part as the optical conversion unit for cooling the liquid crystal panel 3 and the detection switch 26 as a detecting unit for detecting the attitude status of the circulating direction of the cooling medium circulating within the box-shaped cooling unit 22. The device further includes the unidirectional circulation pump 281 for circulating the cooling medium in a single direction. Further, as the switching unit, the device includes the valve 252 and the valve 253 in the A part and B part of the circulation pipe 21 and the device includes the valve control circuit 251 for controlling the valves 252 and 253 to switch the circulation path according to the result detected by the detection switch 26.

Accordingly, even when the projector 1 is installed hanging from the ceiling (at the time of desktop installation, installation in which the cooling medium of the liquid crystal panel 3 circulates from top to bottom), the detection switch 26 can detect that the projector 1 has been turned upside down. Then, the valve control circuit 251 controls the valves 252 and 253 provided in the Apart and B part of the circulation pipe 21 according to the result detected by the detection switch 26. The cooling medium circulating within the box-shaped cooling unit 22 for cooling the liquid crystal panel 3 can be circulated from bottom to top, and thereby, the heat of the liquid crystal panel 3 that has generated heat is efficiently cooled. Therefore, even when the attitude of the projector 1 is turned upside down and the direction in which the cooling medium in the liquid crystal panel 3 circulates changes, the cooling efficiency can be maintained. Thereby, the reliability of the liquid crystal panel 3 can be enhanced.

Further, regarding the production of air bubbles due to heat, air bubbles can be reduced or prevented from remaining in the place where they have been produced because the air bubbles can circulate. Further, the temperature distribution in the optical conversion unit becomes uniform and stable. Therefore, even when the attitude of the projector 1 is turned upside down and the direction in which the cooling medium for cooling the liquid crystal panel 3 as the optical conversion unit circulates changes, the phenomenon “fluctuation” never occurs in the projection image on the screen, and the quality of the projection image can be ensured.

(2) The radiation efficiency can be enhanced by providing the radiation fin 273 as a radiator in the supply tank 27 in some layers for enlarging the radiation area, the heat of the cooling medium heated by the liquid crystal panel 3 can be released with the radiation fin 273, and the heat of the cooling medium can be cooled sufficiently by natural cooling.

### Second Exemplary Embodiment

Next, the second exemplary embodiment of the invention will be described according to the drawings.

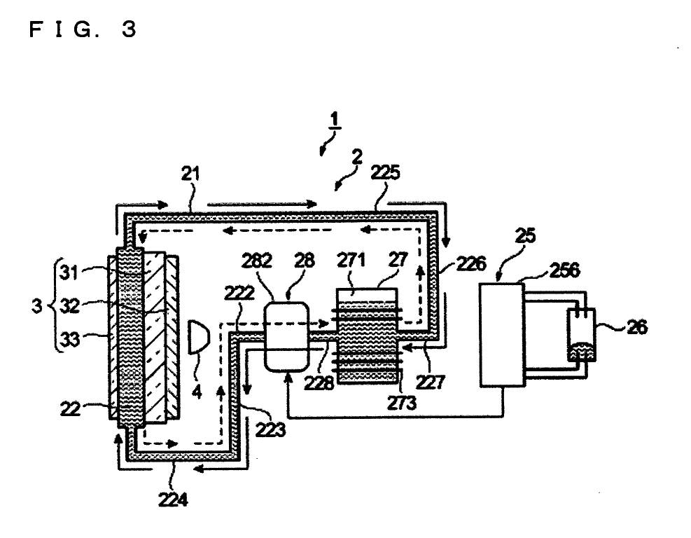

FIG. 3 is a schematic construction view as an exemplary embodiment different from the first exemplary embodiment in the case where a cooling device using a cooling medium is used in a liquid crystal panel in a projector of exemplary embodiments of the invention. Using FIG. 3, the construction and operation will be described.

In the second exemplary embodiment, as the circulation pump 28 that forms the cooling device 2, a bidirectional circulation pump 282 (hereinafter, referred to as “circulation pump 282”) having a function for circulating the cooling medium while switching between the forward direction and the backward direction is provided, which is different from the unidirectional circulation pump 281 for circulating the cooling medium in a single direction adopted in the first exemplary embodiment.

Further, as the switching unit 25, a bidirectional pump control circuit 256 (hereinafter, referred to as “pump control circuit 256”) is provided for performing control of switching the circulation pump 282 between the forward direction and the backward direction based on the detection result by the detection switch 26. Further, since the valves 252 and 253 adopted in the first exemplary embodiment are not provided, the channel becomes different.

The supply tank 27 including the box-shaped cooling unit 22, the detection switch 26, and the radiation fin 273 has the same construction as in the first exemplary embodiment.

Next, the operation will be described.

The circulation operation of the cooling medium in the cooling device 2 in the case where the projector 1 is installed on the desk and used will be described.

The pump control circuit 256 receives the output signal of the detection switch 26 and switches the discharging direction (circulating direction) of the circulation pump 283. When the projector is installed on the desk, the detection switch 26 is in a status shown in FIG. 3. In this condition, the pump control circuit 256 controls the circulation pump 282 to drive in the direction in which the cooling medium is sucked from the supply tank 27 through the circulation pipe 228 into the circulation pump 282. The cooling medium circulates in the direction of the solid line arrow in FIG. 3.

The cooling medium sucked in by the circulation pump 282 is discharged into the circulation pipe 222, and circulates in the circulation pipe 223 and circulates in the circulation pipe 224. Then, the cooling medium flows from the lower side into the box-shaped cooling unit 22 connected to the circulation pipe 224.

In the same manner as in the first exemplary embodiment, the cooling medium that has flown in the box-shaped cooling unit 22 transfers the heat generated by the liquid crystal panel 3 and the heated cooling medium flows out into the circulation pipe 225 connected to the upper side of the box-shaped cooling unit 22. The delivery of heat by the heat transfer cools the liquid crystal panel 3 that has transferred the generated heat to the box-shaped cooling unit 22.

Further, at this time, even when fine air bubbles are produced in the cooling medium, they flow out together into the circulation pipe 225 and the air bubbles never remain within the box-shaped cooling unit 22. Thereby, the temperature distribution of the cooling medium within the box-shaped cooling unit 22 becomes stable as it flows from bottom to top in a condition in which the temperature uniformly becomes higher.

The cooling medium that has flown out from the box-shaped cooling unit 22 circulates in the circulation pipe 225, then circulates in the circulation pipe 226 and the circulation pipe 227 connected thereto, and flows into the supply tank 27.

The heated cooling medium that has flown in the supply tank 27 is naturally cooled by the heat release with the radiation fin 273 provided in the supply tank 27.

Through the above described series of circulation at the time of desktop installation, the liquid crystal panel 3 that has generated heat is cooled. Further, through the series of circulation, the cooling medium draws heat from the liquid crystal panel 3 that has generated heat by heat transfer and is naturally cooled by the radiation fin 273 of the supply tank 27.

Next, the circulation movement of the cooling medium in the cooling device 2 when the projector 1 is installed hanging from the ceiling and used will be described.

The projector 1 is, for ceiling hanging installation, installed with the upper surface of the projector 1 down. Then, in the detection switch 26, the mercury moves in the opposite direction to that shown in FIG. 3 and reversed to the position in the case of desktop installation. The pump control circuit 256 receives the output signal of the detection switch 26 and controls the circulation pump 282 to circulate in the opposite direction (direction shown by the broken line arrow in FIG. 3) to that in the case of the desktop installation.

In this condition, the circulation pump 282 drives the cooling medium to circulate in the circulation pump 282 and the supply tank 27 to suck in the cooling medium. Then, the cooling medium in the supply tank 27 is circulated in the circulation pipe 227 and circulation pipe 226, and circulated in the circulation pipe 225 connected to the box-shaped cooling unit 22. Then, the cooling medium flows from the lower side of the box-shaped cooling unit 22 (since the projector 1 is installed with the attitude upside down, all of the components mounted in the projector 1 such as the cooling device 2 and liquid crystal panel 3 are turned upside down).

The heat generated by the liquid crystal panel 3 is transferred to the box-shaped cooling unit 22, and thereby, transferred to the cooling medium flown in the box-shaped cooling unit 22 in the same manner as in the case of desktop installation of the projector 1. Then, the heated cooling medium by the heat transfer flows out into the circulation pipe 224 connected to the upper side of the box-shaped cooling unit 22 (because the projector 1 is turned upside down). The delivery of heat by the heat transfer cools the liquid crystal panel 3 that has transferred the generated heat to the box-shaped cooling unit 22.

At this time, in the same manner as in the case of desktop installation of the projector 1, the cooling medium sometimes produce fine air bubbles by being heated. However, since the produced air bubbles flow from bottom to top of the box-shaped cooling unit 22 in the same direction as the circulation direction of the cooling medium, they never remain within the box-shaped cooling unit 22 but flows out into the circulation pipe 224. Further, thereby, the temperature distribution of the cooling medium within the box-shaped cooling unit 22 becomes stable as it flows from bottom to top in a condition in which the temperature uniformly becomes higher.

The cooling medium that has flown out from the box-shaped cooling unit 22 circulates in the circulation pipe 224 and the circulation pipe 223. Then, the cooling medium circulates in the circulation pipe 222 and flows into the circulation pump 282. The cooling medium that has flown into the circulation pump 282 circulates in the circulation pipe 228 and flows into the supply tank 27.

The heated cooling medium that has flown in the supply tank 27 is naturally cooled by the heat release with the radiation fin 273 provided in the supply tank 27.

Through the above described series of circulation of the cooling medium at the time of ceiling hanging installation, even when the projector 1 is installed hanging from the ceiling with the attitude of the projector 1 upside down, the liquid crystal panel 3 that has generated heat is cooled in the same manner as in the case of desktop installation of the projector 1. Further, through the series of circulation, the cooling medium draws heat from the liquid crystal panel 3 that has generated heat by heat transfer and is naturally cooled by the radiation fin 273 of the supply tank 27.

According to the second exemplary embodiment described as above, not only the effect (2) in the first exemplary embodiment is similarly obtained, but also the following effects are obtained.

(1) The cooling device 2 in the second exemplary embodiment includes the box-shaped cooling unit 22 provided in the liquid crystal panel 3 part as the optical conversion unit for cooling the liquid crystal panel 3 and the detection switch 26 as a detecting unit for detecting the attitude status of the circulating direction of the cooling medium circulating within the box-shaped cooling unit 22. The device includes the bidirectional circulation pump 282 that can switch the circulating direction of the cooling medium between the forward direction and the backward direction. Further, as the switching unit, the device includes the bidirectional pump control circuit 256 for controlling and switching the circulating direction of the bidirectional circulation pump 282 (between the forward direction and the backward direction) based on the detection result by the detection switch 26.

Accordingly, even when the projector 1 is installed hanging from the ceiling (at the time of desktop installation, installation in which the cooling medium of the liquid crystal panel 3 circulates from top to bottom), the detection switch 26 can detect that the projector 1 has been turned upside down. Then, the bidirectional pump control circuit 256 circulates the circulating direction of the bidirectional circulation pump 282 in the opposite direction to the forward direction and the cooling medium circulating within the box-shaped cooling unit 22 for cooling the liquid crystal panel 3 can be circulated from bottom to top, and thereby, the heat of the liquid crystal panel 3 that has generated heat is efficiently cooled. Therefore, even when the attitude of the projector 1 is turned upside down and the direction in which the cooling medium in the liquid crystal panel 3 circulates changes, the cooling efficiency can be maintained. Thereby, the reliability of the liquid crystal panel 3 can be enhanced.

Further, regarding the production of air bubbles due to heat, air bubbles can be reduced or prevented from remaining in the place where they have been produced because the air bubbles can circulate. Further, the temperature distribution in the optical conversion unit becomes uniform and stable. Therefore, even when the attitude of the projector 1 is turned upside down and the direction in which the cooling medium for cooling the liquid crystal panel 3 as the optical conversion unit circulates changes, the phenomenon “fluctuation” never occurs in the projection image on the screen, and the quality of the projection image can be ensured.

(2) In the construction using the bidirectional circulation pump 282 in the second exemplary embodiment, because the channel can be simply formed without using the valves 252 and 253 used in the first exemplary embodiment, the cooling device can be downsized.

### Third Exemplary Embodiment

Next, the third exemplary embodiment of the invention will be described according to the drawings.

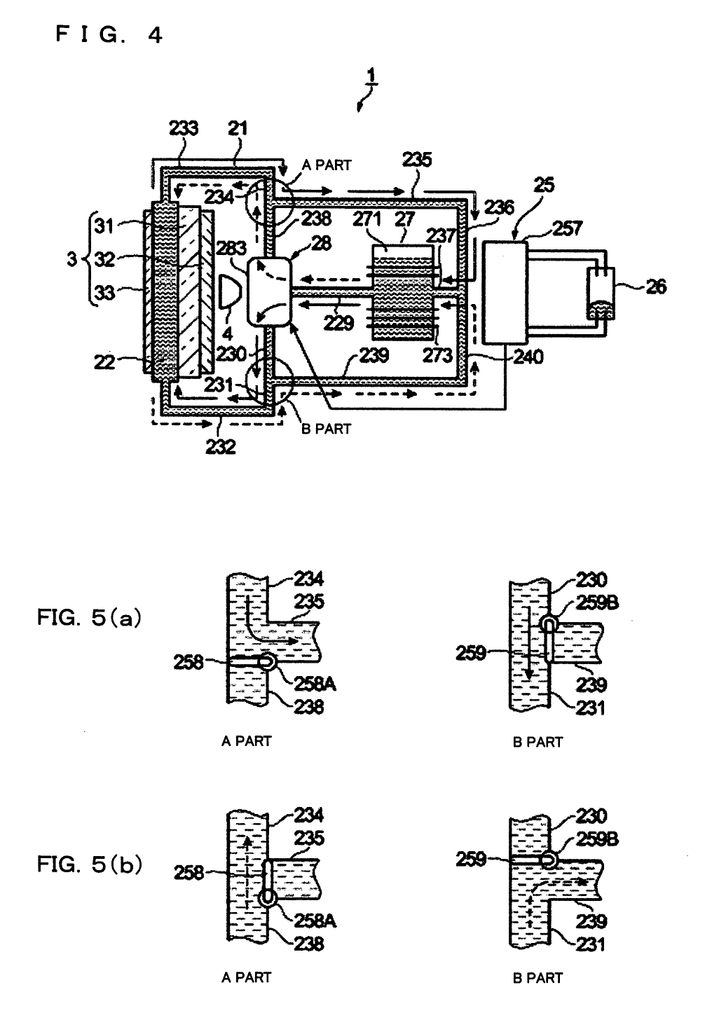

FIG. 4 is a schematic showing an exemplary embodiment different from the first and second exemplary embodiments in the case where a cooling device using a cooling medium is used in a liquid crystal panel in a projector of the invention. FIGS. 5(a) and (b) are enlarged views of A part and B part shown in FIG. 4, and shows the movement of valves that form the switching unit. Further, FIG. 5(a) shows the positions of the valves and the circulating direction of the cooling medium when the projector is installed on the desk. FIG. 5(b) shows the positions of the valves and the circulating direction of the cooling medium when the projector is installed hanging from the ceiling. Using FIGS. 4 and 5, the construction and operation will be described.

In the third exemplary embodiment, as the circulation pump 28 that forms the cooling device 2, a two-way circulation pump 283 (hereinafter, referred to as “circulation pump 283”) having a function for circulating the cooling medium one of two directions (not the forward and backward directions) is provided. Further, as the switching unit 25, a two-way pump control circuit 257 (hereinafter, referred to as “pump control circuit 257”) is provided for performing control of the circulation pump 283 based on the detection result by the detection switch 26. Further, a valve 258 and a valve 259 provided in the circulation pipe 21 for operating according to the pressure of the cooling medium circulating in the circulation pipe 21 and switching the channel are provided. Further, the channels of the parts provided with the valves 258 and 259 are different, however, other parts are the same as in the first exemplary embodiment.

Next, the operation will be described in detail.

The circulation operation of the cooling medium in the cooling device 2 in the case where the projector 1 is installed on the desk and used will be described.

The pump control circuit 257 receives the output signal of the detection switch 26 and switches the discharging direction (circulating direction) of the circulation pump 283. When the projector is installed on the desk, the detection switch 26 is in a status shown in FIG. 4. At this time, the pump control circuit 257 receives the output signal of the detection switch 26 and controls the circulation pump 283 to suck in the cooling medium from the supply tank 27 through the circulation pipe 229. The cooling medium sucked in is discharged in the direction of the solid line arrow shown in the circulation pump 283 in FIG. 4 (in the direction of the circulation pipe 230). At that time, the discharged cooling medium circulates in the circulation pipe 230. Then, as shown by the B part in FIG. 5(a), the B part valve 259 operates in a position where it blocks the circulation pipe 239 with the 259B portion as a support because of the pressure by the circulation of the cooling medium. Accordingly, the cooling medium circulates in the circulation pipe 231. Then, the cooling medium flows from the lower side into the box-shaped cooling unit 22 connected to the circulation pipe 232.

The cooling medium that has flown in the box-shaped cooling unit 22 transfers the heat generated by the liquid crystal panel 3 and the heated cooling medium flows out into the circulation pipe 233 connected to the upper side of the box-shaped cooling unit 22 in the same manner as in the first exemplary embodiment. The delivery of heat by the heat transfer cools the liquid crystal panel 3 that has transferred the generated heat to the box-shaped cooling unit 22.

Further, at this time, even when fine air bubbles are produced in the cooling medium, they flow out together into the circulation pipe 233 and the air bubbles never remain within the box-shaped cooling unit 22. Thereby, the temperature distribution of the cooling medium within the box-shaped cooling unit 22 becomes stable as it flows from bottom to top in a condition in which the temperature uniformly becomes higher.

The cooling medium that has flown out from the box-shaped cooling unit 22 circulates in the circulation pipe 233 and the circulation pipe 234 connected thereto. Then, as shown by the A part in FIG. 5(a), the A part valve 258 operates in a position where it blocks the circulation pipe 238 with the 258A portion as a support because of the pressure by the circulation of the cooling medium. Accordingly, the cooling medium circulates in the circulation pipe 235. Then, the cooling medium circulates in the circulation pipe 236 connected to the circulation pipe 235. Then, the cooling medium circulates in the circulation pipe 237 because the circulation pipe 239 and the circulation pipe 240 connected thereto are closed by the valve 259, and then, flows into the supply tank 27.

The heated cooling medium that has flown in the supply tank 27 is naturally cooled by the heat release with the radiation fin 273 provided in the supply tank 27.

Through the above described series of circulation at the time of desktop installation, the liquid crystal panel 3 that has generated heat is cooled. Further, through the series of circulation, the cooling medium draws heat from the liquid crystal panel 3 that has generated heat by heat transfer and is naturally cooled by the radiation fin 273 of the supply tank 27.

Next, the circulation movement of the cooling medium in the cooling device 2 when the projector 1 is installed hanging from the ceiling and used will be described.

The projector 1 is, for ceiling hanging installation, installed with the upper surface of the projector 1 down. Then, in the detection switch 26, the mercury moves in the opposite direction to that shown in FIG. 3 and reversed to the position in the case of desktop installation. The pump control circuit 257 receives the output signal of the detection switch 26 and drives the circulation pump 283 to switch to discharge the cooling medium in one direction different from that in the case of desktop installation. Then, the circulation pump 283 sucks in the cooling medium from the supply tank 27 through the circulation pipe 229 and discharges the sucked cooling medium in the direction of the broken line arrow shown in the circulation pump 283 in FIG. 4. At that time, the discharged cooling medium circulates in the circulation pipe 238.

Then, as shown by the A part in FIG. 5(b), the A part valve 258 operates in a position where it blocks the circulation pipe 235 with the 258A portion as a support because of the pressure by the circulation of the cooling medium. Accordingly, the cooling medium circulates in the circulation pipe 234. Then, the cooling medium flows from the lower side (since the projector 1 is installed with the attitude upside down, all of the components mounted in the projector 1 such as the cooling device 2 and liquid crystal panel 3 are turned upside down) into the box-shaped cooling unit 22 connected to the circulation pipe 233.

The heat generated by the liquid crystal panel 3 is transferred to the box-shaped cooling unit 22, and thereby, transferred to the cooling medium flown in the box-shaped cooling unit 22 in the same manner as in the case of desktop installation of the projector 1. Then, the heated cooling medium by the heat transfer flows out into the circulation pipe 232 connected to the upper side of the box-shaped cooling unit 22 (because the projector 1 is turned upside down). The delivery of heat by the heat transfer cools the liquid crystal panel 3 that has transferred the generated heat to the box-shaped cooling unit 22.

At this time, in the same manner as in the case of desktop installation of the projector 1, the cooling medium sometimes produces fine air bubbles by being heated. However, since the produced air bubbles flow from bottom to top of the box-shaped cooling unit 22 in the same direction as the circulation direction of the cooling medium, they never remain within the box-shaped cooling unit 22 but flows out into the circulation pipe 232. Further, thereby, the temperature distribution of the cooling medium within the box-shaped cooling unit 22 becomes stable as it flows from bottom to top in a condition in which the temperature uniformly becomes higher.

The cooling medium that has flown out from the box-shaped cooling unit 22 circulates in the circulation pipe 232, and then circulates in the circulation pipe 231. Then, as shown by the B part in FIG. 5(b), the B part valve 259 operates in a position where it blocks the circulation pipe 230 with the 259B portion as a support because of the pressure by the circulation of the cooling medium. Accordingly, the cooling medium circulates in the circulation pipe 239. Then, the cooling medium circulates in the circulation pipe 240 connected to the circulation pipe 239. Then, the cooling medium circulates in the circulation pipe 237 because the circulation pipe 235 and the circulation pipe 236 connected thereto are closed by the valve 258, and then, flows into the supply tank 27.

The heated cooling medium that has flown in the supply tank 27 is naturally cooled by the heat release with the radiation fin 273 provided in the supply tank 27.

Through the above described series of circulation at the time of ceiling hanging installation, the liquid crystal panel 3 that has generated heat is cooled. Further, through the series of circulation, the cooling medium draws heat from the liquid crystal panel 3 that has generated heat by heat transfer and is naturally cooled by the radiation fin 273 of the supply tank 27.

According to the third exemplary embodiment described as above, not only the effect (2) in the first exemplary embodiment is obtained, but also the following effects are obtained.

(1) The cooling device 2 in the third exemplary embodiment includes the box-shaped cooling unit 22 provided in the liquid crystal panel 3 part as the optical conversion unit for cooling the liquid crystal panel 3 and the detection switch 26 as a detecting unit for detecting the attitude status of the circulating direction of the cooling medium circulating within the box-shaped cooling unit 22. The device includes the two-way circulation pump 283 that can switch the circulating direction of the cooling medium to one of two directions. Further, as the switching unit, the device includes the two-way pump control circuit 257 for controlling and switching the circulating direction of the two-way circulation pump 283 based on the detection result by the detection switch 26, and the valve 258 and valve 259 provided in the A part and B part of the circulation pipe 21 for operating according to the pressure by the circulation of the cooling medium and switching the channel.

Accordingly, even when the projector 1 is installed hanging from the ceiling (at the time of desktop installation, installation in which the cooling medium of the liquid crystal panel 3 circulates from top to bottom), the detection switch 26 can detect that the projector 1 has been turned upside down. Then, the two-way pump control circuit 257 switches the circulating direction of the two-way circulation pump 283 and circulates the cooling medium. At that time, the valves 258 and 259 provided within the circulation pipe 21 operate because of the pressure of the circulating cooling medium and change the channel and the cooling medium circulating within the box-shaped cooling unit 22 for cooling the liquid crystal panel 3 can be circulated from bottom to top. Thereby, the heat of the liquid crystal panel 3 that has generated heat is efficiently cooled. Therefore, even when the attitude of the projector 1 is turned upside down and the direction in which the cooling medium in the liquid crystal panel 3 circulates changes, the cooling efficiency can be maintained. Thereby, the reliability of the liquid crystal panel 3 can be enhanced.

Further, regarding the production of air bubbles due to heat, air bubbles can be reduced or prevented from remaining in the place where they have been produced because the air bubbles can circulate. Further, the temperature distribution in the optical conversion unit becomes uniform and stable. Therefore, even when the attitude of the projector 1 is turned upside down and the direction in which the cooling medium in the liquid crystal panel 3 as the optical conversion unit circulates changes, the phenomenon “fluctuation” never occurs in the projection image on the screen, and the quality of the projection image can be ensured.

Note that, the invention is not limited to the above described exemplary embodiments, and various changes and enhancements can be made to the above described exemplary embodiments. Modified examples will be described as below.

### MODIFIED EXAMPLE 1

In the exemplary embodiments, the optical conversion unit to be cooled is implemented as the liquid crystal panel 3. However, not limited to that, the optical conversion unit may be implemented by a polarization conversion element for converting the exiting light from the light source 4 into polarized light direction in a single direction. Thereby, also the heat generated by a retardation film that forms the polarization conversion element can be cooled, and, even when the projector 1 is installed hanging from the ceiling, the same cooling efficiency can be maintained as in the case where the projector 1 is installed on the desk. Thereby, the reliability of the polarization conversion element can be enhanced. Further, the same effect can be obtained by implementing for other optical conversion units that generate heat.

### MODIFIED EXAMPLE 2

In the exemplary embodiments, the detection switch 26 is provided as a detecting unit for detecting the attitude status of the projector 1 that changes the circulating direction of the cooling medium circulating within the box-shaped cooling unit 22. Further, the detection switch 26 detects the attitude using the mercury switch according to at which side the switch is “ON” from the movement of mercury. However, not limited to that, a microswitch may be used. In this case, detection can be realized because, at the time of desktop installation, the microswitch hits against the desk and the switch is turned “ON”, and, at the time of ceiling hanging installation, the microswitch hits against nothing and the switch is turned “OFF”.

Further, an angle sensor may be used. In the case of using an angle sensor, it can more precisely detect that the projector 1 is tilted from the attitude status in which the cooling medium circulating within the box-shaped cooling unit 22 for cooling the optical conversion unit circulates from bottom to top, to the attitude status in which the cooling medium circulates from top to bottom. Thereby, the switching of circulation of the cooling medium can be precisely timed.

### MODIFIED EXAMPLE 3

The supply tank 27 including the circulation pipe 21 and the radiation fin 273 in the above described exemplary embodiments is provided at the surface side of a housing case that forms the housing of the projector 1 as inner as possible. Thereby, the heat release effect can be enhanced. Especially, when a slit-shape hole or the like is provided in the side surface of the housing case and the supply tank 27 is provided near the hole, the heat released from the radiation fin 273 can be escaped to the outside of the projector 1. Thus, the cooling efficiency can be further enhanced.

### MODIFIED EXAMPLE 4

In the above described exemplary embodiments, as the cooling medium, ethylene glycol is used, however, gases such as nitrogen (N₂) gas and argon (Ar) gas, or liquids such as pure water, fluorinated hydrocarbon, or silicon oil can be used. In this case, the circulation pump can be implemented using a circulation pump for air. Thereby, image quality can be enhanced even in the case of using gas. Then, the degree of freedom to choose the used cooling medium is increased.

### MODIFIED EXAMPLE 5

In the above described exemplary embodiments, as the material of the circulation pipe 21 and the radiation fin 273, a metal containing copper having high thermal conductivity is used. However, the invention is not limited to that, a metal having high thermal conductivity such as an aluminum alloy can be used.

### MODIFIED EXAMPLE 6

In the above described exemplary embodiments, the projector 1 adopts the transmissive liquid crystal system display device, however, it is not limited to that. For example, exemplary embodiments of the invention can be applied to projectors adopting DLP (registered trademark) (Digital Light Processing) system, CRT (Cathode-Ray Tube) system, and LCOS (Liquid Crystal On Silicon) system as a reflective liquid crystal system. Thereby, cooling efficiency of the optical conversion unit can be enhanced for projectors adopting various systems. Further, the phenomenon “fluctuation” can be reduced or prevented.

1. A projector to enlarge and project image data, the projector comprising:
a light source;
an optical conversion unit to perform conversion of exiting light from the light source; and
a cooling device to cool the optical conversion unit using a cooling medium, the cooling device including a circulation path for the cooling medium, a pump to circulate the cooling medium, a detecting unit to detect that a circulating direction of the cooling medium in the optical conversion unit to be cooled is an attitude to circulate from top to bottom, and a switching unit to switch the circulating direction of the cooling medium to cool the optical conversion unit so that the circulating direction of the cooling medium may be from bottom to top based on a detection result by the detecting unit.

2. The projector according to claim 1, the switching unit including a valve provided within the circulation path to switch a channel and a control unit to control the switching of the valve based on the detection result by the detecting unit.

3. The projector according to claim 1, the pump being arranged so as to switch the circulating direction of the cooling medium between a forward direction and a backward direction, and
the switching unit being formed by a control unit to control the switching of the pump based on the detection result by the detecting unit.

4. The projector according to claim 1, the pump being arranged so as to switch the circulating direction of the cooling medium at least between two directions, and
the switching unit being formed by a control unit to control the switching of the pump based on the detection result by the detecting unit and a valve provided within the circulation path to operate according to pressure, by the circulation of the cooling medium and switching a channel.

5. The projector according to claim 1, further comprising:
a supply tank to supply the cooling medium, the supply tank including a radiation unit.

6. The projector according to claim 1, the detecting unit performing detection when the projector is installed on a desk and installed hanging from a ceiling.
